(19) United States
(12) Patent Application Publication
(10) Pub. No.: US 2024/0386300 A1
(43) Pub. Date: Nov. 21, 2024

(54) CONSOLIDATED EXPLAINABILITY

(71) Applicant: Telefonaktiebolaget LM Ericsson (publ), Stockholm (SE)

(72) Inventors: Sunil Kumar VUPPALA, Bangalore (IN); Saurabh SINGH, Vallentuna (SE); Kristijonas CYRAS, San José, CA (US); Anusha Pradeep MUJUMDAR, Bangalore (IN); Arpit SISODIA, Noida Uttar Pradesh (IN); Wenfeng HU, Täby (SE); Sai Hareesh ANAMANDRA, Bangalore, Karnataka (IN)

(21) Appl. No.: 18/691,588

(22) PCT Filed: Sep. 14, 2021
(86) PCT No.: PCT/EP2021/075240

§ 371 Date: Mar. 13, 2024

(51) Int. Cl. G06N 5/045; G06N 5/022

(52) U.S. Cl. CPC G06N 5/045; G06N 5/022

(57) ABSTRACT

There is provided a method for consolidating explanations associated with actions proposed based on a current state of a system and an intent. The method includes acquiring first and second explanations, the first and second explanations being associated with a proposed action or with different actions, wherein each of the first and second explanations includes one or more constraints, combining constraints from the first and second explanations to form a set of constraints D, generating a planning problem P=<K, A, I, G, Cost>, wherein K consists of a set of predicates F and the set of constraints D, wherein A represents a set of possible actions, I represents an initial state of the system, G represents a goal state of the system, and Cost represents cost values associated with each constraint, and determining a solution for the planning problem.

### TECHNICAL FIELD

The present disclosure relates to the field of end-to-end composition of explainability in artificial intelligence. In particular, the present disclosure relates to methods and apparatuses for consolidating explanations associated with proposed actions based on a state of a system and an intent.

### BACKGROUND

Artificial intelligence (AI) is going to play a major role in the management of communication networks of tomorrow, and there is growing need for AI systems to be trustworthy. There is growing attention and need for Trustworthy AI, and explainability of AI systems goes hand in hand with that. Explainable artificial intelligence (XAI) is a set of processes that help humans understand and interpret a purpose, a rationale, and/or a decision-making process of the AI. For example, XAI allows interpretation of prediction of a model, understanding the behaviour of the model with respect to various inputs, and the debugging of such model.

### SUMMARY

Some of the problems with current AI systems stem from the issue that at present there is either none or very basic explanation provided. The explanation provided is usually limited to the explainability framework provided by ML model explainers such as Local Interpretable Model-Agnostic Explanations (LIME), SHapley Additive explanations (SHAP), and Explain Like I'm 5 (ELI5), and is focussed on the component the ML model is running. Neural networks are typically complex as there would be hundreds of nodes in the entire network. If the explanation provided by the AI system is very component-oriented, it would not help in explaining the overall recommendation/action required to solve the problem. In some cases, the explanation provided by one component can also conflict with that of another component.

In the context of artificial intelligence (AI) and machine learning (ML), there may be multiple agents involved in solving for an end-to-end intent. This means that there may be multiple explanations in a solution flow, including, for example, data explanations and model global/local explanations. It is likely that the explanations provided by multiple agents are not entirely consistent with each other, or even conflict with each other.

For example, consider a scenario where the overall intent received by an AI system is to decrease the energy consumption in a 4G network by a certain percentage (e.g., 2%). This high-level intent can be broken down into service level goals and further broken down into network level and Key Performance Indicator (KPI) level goals and values. Once this is broken down into network level goals and KPI values, it can be established that certain Evolved Universal Terrestrial Radio Access Network Frequency-division Duplexing (EUTRANFDD) cells should decrease their downlink transmission power to achieve a 2% drop in energy consumption. To reach this goal state, it may be further determined that the transmission power on Cell A and Cell B need to be reduced. The same explanation can be provided to a higher-level reasoner. However, there is a problem with this technique—the subsystem in question does not have visibility of other subsystems. Once the higher-level reasoner starts receiving explanations from other subsystems, it can determine whether the overall explanation is acceptable or certain parts of it are in conflict. The overall composition of the explanation and conflict resolution may be problematic in some AI systems.

One aspect of the present disclosure provides a computer-implemented method for consolidating explanations associated with one or more actions proposed based on a current state of a system and an intent. The method comprises: acquiring a first explanation and a second explanation, wherein the first and second explanations are associated with a proposed action or are associated with different actions, and wherein each of the first and second explanations includes one or more constraints, each constraint representing a requirement to satisfy a problem corresponding to the intent, combining constraints from the first and second explanations to form a set of constraints D, generating a planning problem P=<K, A, I, G, Cost>, wherein K consists of a set of predicates F in a domain of the system and the set of constraints D, wherein A represents a set of possible actions associated with the first explanation and/or the second explanation, I represents an initial state of the system, G represents a goal state of the system corresponding to the intent, and Cost represents cost values associated with each constraint in the set of constraints, and determining a solution for the planning problem P, wherein the solution represents a consolidated explanation based on the first and second explanations.

Another aspect of the present disclosure provides a computer program product, embodied on a non-transitory machine-readable medium, comprising instructions which are executable by processing circuitry to cause the processing circuitry to perform the method according to any one of claims 1 to 14.

Another aspect of the present disclosure provides an apparatus for consolidating explanations associated with one or more actions proposed based on a current state of a system and an intent, the apparatus being configured to perform the method as described herein.

Another aspect of the present disclosure provides an apparatus for consolidating explanations associated with one or more actions proposed based on a current state of a system and an intent. The apparatus comprises processing circuitry coupled with a memory, wherein the memory comprises computer readable program instructions that, when executed by the processing circuitry, cause the apparatus to acquire a first explanation and a second explanation, wherein the first and second explanations are associated with a proposed action or are associated with different actions, and wherein each of the first and second explanations includes one or more constraints, each constraint representing a requirement to satisfy a problem corresponding to the intent. The apparatus can be further caused to combine constraints from the first and second explanations to form a set of constraints D, and to generate a planning problem P=<K, A, I, G, Cost>, wherein K consists of a set of predicates F in a domain of the system and the set of constraints D, wherein A represents a set of possible actions associated with the first explanation and/or the second explanation, I represents an initial state of the system, G represents a goal state of the system corresponding to the intent, and Cost represents cost values associated with each constraint in the set of constraints. The apparatus can be further caused to determine a solution for the planning problem P, wherein the solution represents a consolidated explanation based on the first and second explanations.

Another aspect of the present disclosure provides an apparatus for consolidating explanations associated with one or more actions proposed based on a current state of a system and an intent. The apparatus comprises: acquiring module configured to acquire a first explanation and a second explanation, wherein the first and second explanations are associated with a proposed action or are associated with different actions, and wherein each of the first and second explanations includes one or more constraints, each constraint representing a requirement to satisfy a problem corresponding to the intent, combining module configured to combine constraints from the first and second explanations to form a set of constraints D, generating module configured to generate a planning problem P=<K, A, I, G, Cost>, wherein K consists of a set of predicates F in a domain of the system and the set of constraints D, wherein A represents a set of possible actions associated with the first explanation and/or the second explanation, I represents an initial state of the system, G represents a goal state of the system corresponding to the intent, and Cost represents cost values associated with each constraint in the set of constraints, and determining module configured to determine a solution for the planning problem P, wherein the solution represents a consolidated explanation based on the first and second explanations.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1A is a diagram illustrating how a proposal can be found and a corresponding explanation can be provided by an explainer module;

FIG. 1B is a diagram illustrating how a combined planner and explainer module can resolve conflicting explanations;

FIG. 2 is a flowchart for a combined planner and explainer module, according to embodiments of the disclosure;

FIG. 3 is a flowchart illustrating a method for consolidating explanations associated with one or more actions proposed based on a current state of a system and an intent, according to embodiments of the disclosure; and

FIG. 4 is a block diagram of an apparatus for consolidating explanations associated with one or more actions proposed based on a current state of a system and an intent, according to embodiments of the disclosure; and

FIG. 5 is a schematic diagram illustrating a deployment view of a machine reasoning environment including a combined planner and explainer module and a conflict resolver component, according to embodiments of the disclosure.

### DETAILED DESCRIPTION

Embodiments described herein relates to methods, modules, and systems for consolidating explanations associated with one or more actions proposed based on a current state of a system and an intent. The proposed technique according to at least some embodiments involve taking explanations from outputs of different agents (rather than just the outputs) to identify conflicts among explanations and therefore corresponding actions, using a conflict resolution agent within an explainer to reconcile multiple explanations, and the use of a combined planner and explainer module.

Embodiments of the present disclosure address problems associated with how a system handles conflicts in explanations if the results are not matching from one subsystem with another in an end-to-end AI system. In certain cases, the explanations provided by one subsystem may be accurate locally, but not consistent with the global solution view. A higher-level explainer can help provide a consistent explanation while taking into account the overall goal. Embodiments of the present disclosure propose a solution for such an explainer that can resolve conflicts between multiple explanations and find a consistent solution (or plan) if possible. Moreover, some embodiments of the present disclosure can take complimentary explanations and collate it to provide an appropriate solution.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

In a use case of an embodiment of the present disclosure, a machine reasoning system may receive an intent to decrease energy consumption in a 4G network by a certain percentage, for example in this case by 2%. This high-level business intent may be represented by service level goals, which are in turn represented by network level and KPI level goals and values. Based on the network level goals and KPI values, it may be determined that certain EUTRANFDD cells should decrease their downlink transmission power to achieve the 2% drop in energy consumption. This intent may be handled by multiple agents, for example:
A Service Orchestrator, which is responsible for managing the network, may translate intents into KPI targets and associated priorities, as well as define policies to achieve the relevant targets. There are various strategies for implementing the service orchestration tasks. In this case, the intent can be regarded as “decrease energy consumption in the 4G network by 2%”, which is translated into service level goals and network level goals, among which includes “decrease EUTRANFDD cell downlink transmission power”
A Network Emulator, which simulates the effect of decreasing transmission power at the radio unit side, may determine that there is no breach of the Service Level Agreements (SLAs), where one of the SLA may be coverage-related, e.g. handover success rate
A ML agent may predict traffic for the next hour and the prediction may be that there is no traffic or limited traffic in the coverage area. The ML agent may be a regression model taking 4G cell KPIs as input and providing average active RRC connected users as output, or it may be a random forest classifier taking snapshots of past traffic as input and yielding expected traffic as output, or it may be a time series analysis-based model (such as long short-term memory (LSTM) artificial recurrent neural network (RNN) architecture) taking network performance counter/KPI measurements as input and yielding their predicated value as output
A Recommender which may propose to decrease transmission power on Cell A and Cell B. This could be, for example, a rule-based system for inferring actions based on given network states, or a constraint solver aiming to satisfy SLA requirements based on given varying network traffic, or a ML-based recommender system (trained on datasets encompassing network states, alerts, and actions taken in those situations), or a model-based (e.g., Markov Decision Process (MDP)) reinforcement learning agent
An Explainer which may explain that decreasing power on Cell A and Cell B would be within the SLAs, accounting for the fact that the corresponding area has limited traffic, and that even there is service request from UEs at the previous cell border, they could still attach to other cells C and D (with weaker radio signal strengths). In the case of rule-based systems, the explanation could amount to a proof or a trace of rules applied to infer the conclusion, given the facts about the network state. For a constraint solver, the explanation could amount to the set of mutually satisfiable constraints, indicating the variables and their value intervals within which the constraints remain satisfiable. Explanations for ML or RL based recommenders could amount to the features (in the case of ML) or the predicates (in case of RL) and their values (which characterise the input state) that have the greatest impact on the output recommendation. These explanations techniques are described in more detail in K. Čyras et al., “Machine Reasoning Explainability,” 2020, E. Puiutta and E. M. S. P. Veith, “Explainable Reinforcement Learning: A Survey,” in Machine Learning and Knowledge Extraction—4th International Cross-Domain Conference, 2020, pp. 77-95, doi: 10.1007/978-3-030-57321-8_5, and A. Barredo Arrieta et al., “Explainable Artificial Intelligence (XAI): Concepts, Taxonomies, Opportunities and Challenges Toward Responsible AI,” Inf. Fusion, vol. 58, no. December 2019, pp. 82-115, 2020, doi: 10.1016/j.inffus.2019.12.012.
A Planner which may be responsible for reasoning out a sequence of actions to reach the goal states. In this example, the goal state is to decrease downlink transmission power on Cell A and Cell B. It is noted that this happens at a lower granularity, i.e., the Planner now has more visibility into the lower-level state action transitions and constraints applicable in its context. This hierarchical breakdown is a typical way to handle complexity in large systems. The Planner may typically be implemented using standard automated planning techniques, e.g., forward chaining state space search, backward chaining search, probabilistic planning (MDP-based), temporal planning, etc.

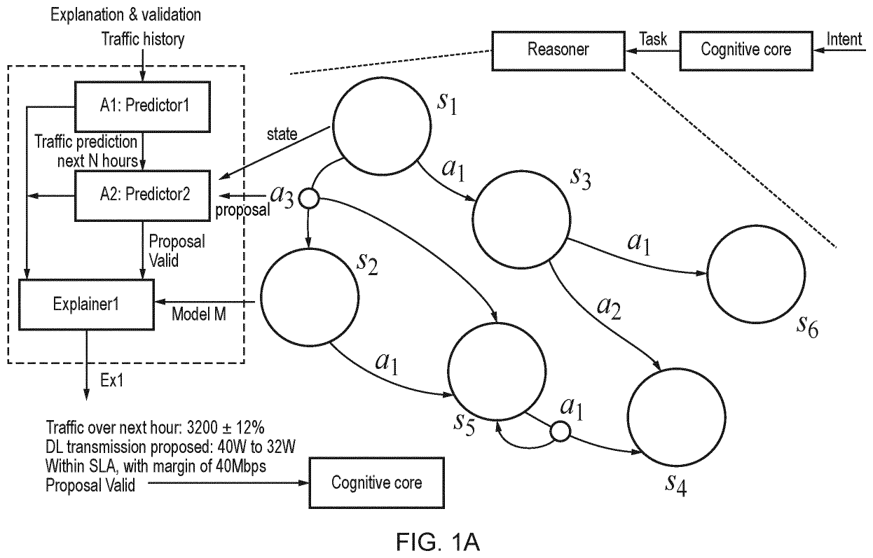

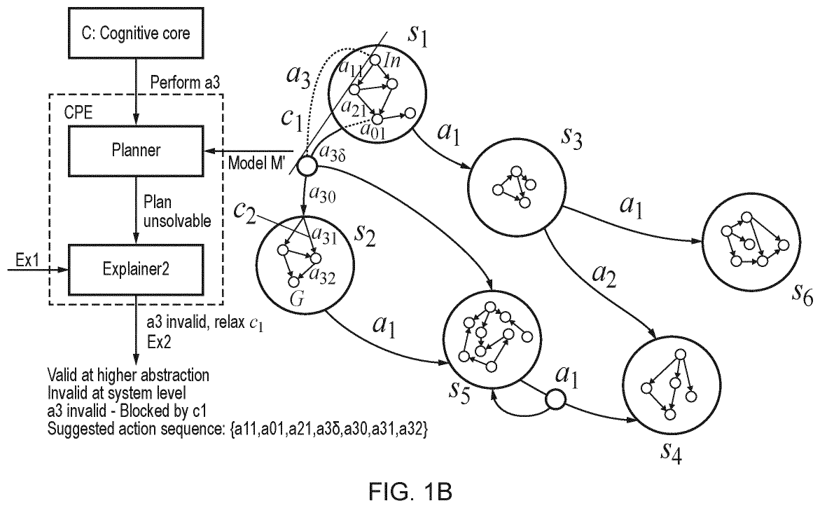

The explanation (e.g., Ex1 as shown in FIG. 1A) may be acceptable until it results in a conflict from an explanation originating from another sub-system (when the Planner tries to plan its actions), which may use knowledge that some states are not safe (e.g., cell power or frequency dropping suddenly and causing faults) and thus certain associated actions should not be taken or that some constraints should be satisfied—these may be in conflict with the actions and/or constraints associated with the explanation. The highest-level Reasoner may combine inputs from all the Recommenders and a knowledge base to determine whether it is possible to reduce bandwidth immediately, as frequency changes need to happen in steps or phases. This may be captured as knowledge asset from a domain expert, and thus actuation is done only stepwise. In other words, the initial explanation (e.g., Ex1) conflicts with an explanation from another explainer which states that reducing frequency in one go is not possible, and the higher-level Explainer can normalize/consolidate the explanations and provide a resulting consistent explanation.

All this architecture could well be implemented using the cognitive layer. The cognitive layer consists of three essential components: a knowledge base, a reasoning engine, and an agent architecture. The knowledge base contains the ontology of intents along with domain-specific knowledge such as the current state of the system. The domain-independent reasoning engine uses the knowledge graph and serves as the central coordinator function for finding actions, evaluating their impact and ordering their execution. Finally, the agent architecture allows any number of models and services to be used. Agents can contain machine-learned models or rule-based policies, or implement services needed in the cognitive reasoning process.

FIG. 1A is a diagram illustrating how a proposal can be found and a corresponding explanation can be provided by an explainer module. As shown in FIG. 1A, there is provided a system including an explanation and validation module, a reasoner, and a cognitive core. The explanation and validation module comprises a first predictor Predictor1, a second predictor Predictor2, a first explainer Explainer1. The diagram further illustrates a state space which includes a plurality of states s₁ to s₆.

When invoked by the cognitive core to check which parts of a received intent are not satisfied and causing problems, the reasoner may search through the state space to find a feasible solution (also referred to as a “proposal” herein) to satisfy the intent. The reasoner may obtain inputs from other agents such as the first predictor Predictor1 and the second predictor Predictor2 to identify key knowledge pieces required for the solution. A Model M captures the declarative and procedural knowledge and the resulting state space. For instance, an external planning agent has a Markov Decision Process (MDP) model M that encodes the declarative knowledge (such as safety constraints) and the procedural knowledge (such as low-level actions and their effects) as well as the resulting state space of the system.

In this example, the first predictor can receive information on traffic history of the system and provide traffic prediction for the next N hours (where N is a predetermined number) to the first explainer and the second predictor. The second predictor can receive input including: a current state of the system and the proposal (i.e., the solution identified by the reasoner) from the state space and the reasoner, and traffic prediction for the next N hours provided by the first predictor. Then, based on the traffic prediction for the next N hours and the current state of the system, the second predictor can validate the proposal.

The first explainer can receive results of the validation from the second predictor, traffic prediction for the next N hours, and the model M, and provide an explanation corresponding to the proposal based on the received information.

In this case, it is predicted by the first predictor that the traffic over the next hour would be “3200Mb±12%”, and the proposal provided by the reasoner is to reduce downlink (DL) transmission from 40 W to 32 W. The second predictor can then validate whether this proposal is valid based on related service level agreements (SLAs), for example confirming whether that it is within a service level agreement with a margin of 40 Mbps. The results of the validation can then be provided back to the cognitive core, as shown in FIG. 1A.

FIG. 1B is a diagram illustrating how a combined planner and explainer module can resolve conflicting explanations. As shown in FIG. 1B, there is provided a system including a cognitive core and combined planner and explainer module. The combined planner an explainer (CPE) module includes a planner and a second explainer Explainer2 (to distinguish from the first explainer shown in FIG. 1A). The diagram further illustrates a state space which includes a plurality of states s₁ to s₆.

The combined planner and explainer module in the present embodiment is an autonomous planning agent combined with a greedy constraint relaxation mechanism. This module can be implemented as an agent interfacing with the cognitive layer. The combined planner and explainer module can list out the constraints each associated with a requirement to satisfy a planning problem (e.g., extracted from the explanation Ex1), and if the constraints are conflicting the combined planner and explainer module can relax them combinatorically, seeking the minimal set of constraint relaxations that would make the planning problem solvable.

In some embodiments, relaxing constraints may correspond to removing subsets of predicates in a goal state of the system. In this case, the explanation would be a minimal subset of constraints, removing which would make the problem solvable. In other words, the minimal subset of constraints is the hurdle to cross to make the problem solvable and therefore can be provided as an explanation.

The functionality of the combined planner and explainer module can be regarded to include the following steps:
The CPE module can receive the following input:
   The original proposal, i.e., a3 as shown in FIG. 1B being provided by the cognitive core
   The model at the appropriate level of abstraction, M′
      For example, if a high-level action is to reduce power, then the appropriate abstraction of the corresponding low-level actions consists of, for example, “reducing power in several selected components (such as Central Processing Units in a radio) in parallel, in certain increments over predetermined time steps”.
   Initial and goal states of the system.
   The set of constraints D {c1, c2, . . . }
The CPE module attempts to solve the planning problem P=<K, A, I, G, Cost>. K consists of a set of predicates F in a domain of the system (which describe the states of the system, such as a value of the current power consumption in a cell, timestamps and values related to downlink transmission), and the set of constraints D. A represents a set of possible actions associated with at least one of the conflicting explanations, and in this example it may consist of a₁, a₂, a₃, . . . a₁₁, a₃₁, a₃₂, a_{3δ} as shown in FIG. 1B). I represents an initial state of the system, and G represents a goal state of the system corresponding to the intent. More specifically, in this example I (within s₁) and G (within s₂) are represented as sets of predicates from K. Cost represents cost values associated with each constraint in the set of constraints. More specifically, Cost may be numerical values assigned to combination of elements in D, e.g., Cost(c1)=100, Cost(c1, c2)=1000.
If a solution is found, the corresponding plan π is sent to the cognitive layer (or a higher-level reasoner), and it is confirmed that the proposed action is feasible.
If no solution is found, an explanation is sought. The CPE may include a conflict resolver (CR) component that performs the following functions:
   The CR component can relax each set of constraints {c1, c2, . . . }. This could be, for example, c1, c2, c1\hat{ }c2 etc. The CPE module can maintain a table on whether relaxing each of these “subsets” lead to the problem being solvable, and if so, the cost of relaxing the relevant constraint(s), as well as the plan cost. The plans each corresponding to a different subset of constraints may be acquired from a knowledge base, and each plan may be associated with a cost associated with the intent. An exemplary table is provided below to illustrate this aspect:

| | | |
|---|---|---|
| c1 | Problem solvable, plan π1, | constraint_Cost = 100 |
| | plan_cost = 200 | |
| c1 ∧ c2 | Problem solvable, plan π2, | constraint_Cost = 1000 |
| | plan_cost = 100 | |

The CR component can then select the minimal cost constraint relaxation (both in terms of plan cost and constraint relaxation cost) to make the problem solvable
The selected constraint(s), i.e., c1 in this example, would be the explanation for why the original proposal was invalid, and the corresponding plan found π′ is the new feasible solution.

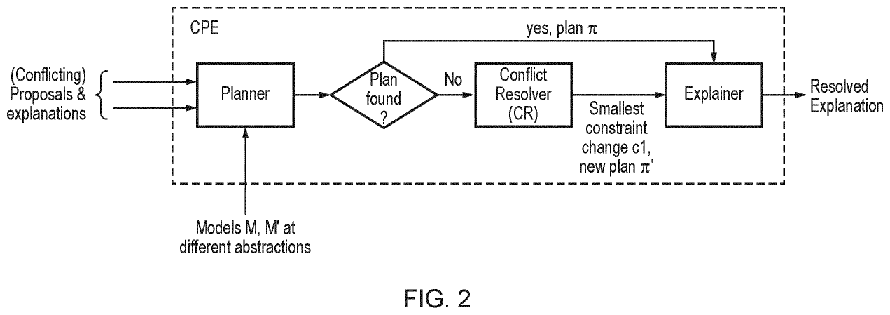

The functionality of the combined planner and explainer (CPE) module as described above is also represented in the flowchart of FIG. 2. As shown in FIG. 2, proposals corresponding to potentially conflicting (or even non-conflicting) explanations are provided to the planner component of the CPE module, along with models M and M′ at respectively different abstractions. If a plan is found (without having to relax the constraints), then the corresponding plan IT is provided to the explainer and then subsequently outputted. On the other hand, if a plan is not found, the conflict resolver component can relax constraint(s) combinatorically as described above, and select the minimal cost constraint relaxation. In this case, the corresponding plan π′ is provided to the explainer and then subsequently outputted.

Although the example described above relate to the scenario involving two conflicting explanations and two constraints, it will be appreciated that the technique described herein is applicable to scenarios involving multiple explanations and/or multiple constraints.

Applying the technique described herein to the scenario of energy management, the first explanation (e.g., as provided by the first explainer in FIG. 1A) may be that reducing downlink (DL) transmission on cell A and cell B in the next hour will satisfy the energy saving intent, while still keeping relevant parameters within what is dictated in relevant service level agreements. The second explanation (e.g., as provided by the second explainer in FIG. 1B) may be that reducing DL transmission in one go may result in call drops and degradation KPIs that are specially related to accessibility and mobility, and thus DL transmission should be reduced in steps of 15-minute time windows to ensure that cell relations can be created automatically and handovers between cells can happen smoothly.

In the energy management scenario, the CPE module can take input from all recommenders and the knowledge base in order to determine that it is not possible to reduce DL transmission immediately, and the reduction needs to happen in steps or phases. This is derived from the lowest cost constraint that renders the problem solvable. The corresponding plan accounting for this constraint can also be output by the CPE module, and it reflects that the actuation should also be done in steps or phases. This explanation along with the new plan can be sent to the cognitive layer for execution. The explanation can also be captured as a knowledge asset. More specifically, the explanation may be captured as the set of constraints relaxed given the whole collection of constraints, and the cost associated to this relaxation: ({c:c is a problem constraint}, {c′:c′ was relaxed}, cost},

In this particular example, the explanation from one explainer was in conflict with that from another explainer, which indicated that reducing DL transmission power in one go is not possible (or desirable). The higher-level explainer (which is the CPE module) resolves these and provides a consolidated explanation.

Another example is also described herein to illustrate how the proposed technique can take complementary explanations and collate them to provide an appropriate consolidated explanation. This example considers a situation of a “hardware fault” prediction alarm. It may be that due to a faulty fan, the temperature at a site has risen, resulting in hardware fault. The first explanation in this case may be that “because of the faulty fan, the temperature has risen beyond the benchmark, and it is predicted that the hardware will fail if action is not taken within 30 minutes”. The second explanation in this case may be derived from analysis of historical data which indicates that this is a recurring issue. More specifically, the agent may generate the explanation based on site information, e.g., that the dimensions of the site are not appropriate and thus they are the cause of the recurring issue.

In this particular example, both explanations are valid and when they are provided to the CPE module, the CPE module collates these explanations and sends them to the cognitive layer, which has the option to take both of the corrective actions:
Replace the faulty fan so that normal functioning of the site can continue
Provide recommendation to the Network Operations Center (NoC) operator to carry out a site visit and modify the dimensions of the site. This may be taken into account in site planning, and this may be, for example, executed in a few weeks' time.

The CPE module and/or the CR component as described above may be implemented as self-contained micro-services deployed in a machine learning environment. In some embodiments, at least some functions can be virtualized and/or performed in a cloud implementation. For example, functions of the CPE module and/or the CP component may can embodied in hardware and/or software of a host computer, which may be a standalone server, a cloud-implemented server, a distributed server or as processing resources in a server farm. The host computer may be under ownership or control of a service provider, or may be operated by service provider or on behalf of the service provider.

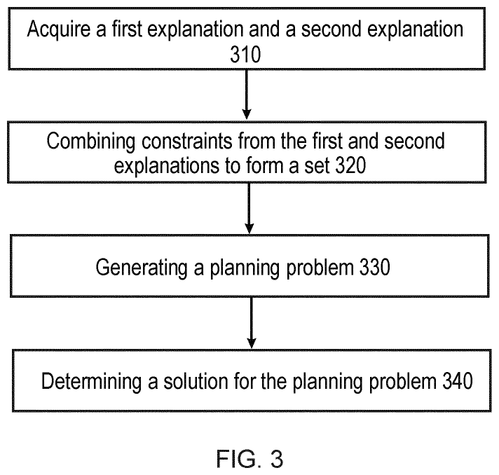

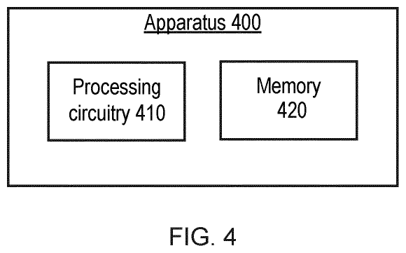

FIG. 3 is a flowchart illustrating a method for consolidating explanations associated with one or more actions, according to embodiments of the disclosure. The illustrated method can generally be performed by or under the control of processing circuitry, such as the processing circuitry of the apparatus 400 as will be described below with reference to FIG. 4. Alternatively, the illustrated method may be performed at a combined planner and explainer module in the system.

In some embodiments, the system may be at least part of a communication network, and in these embodiments the intent may represent an aggregate operational goal to be reached by the communication network. More specifically, the intent may be a specific type of policy in the form of a declaration of high-level business and operational goals or states that the system should meet, without specifying how to achieve them (i.e., not prescribing events, conditions, or actions). Thus, intents can be regarded as policies in the sense that they provide rules for choosing the behaviour of the system, but they do not refer to specification of events, conditions, or actions. As an example, consider the case of a firewall or website filter. A policy in this example may be: “When a request comes in port 80, if Hyper Text Transfer Protocol (HTTP) Uniform Resource Locator (URL) is example.com, block the request”. A corresponding intent may be: “Web traffic to example.com is forbidden”. The actual enforcement of the intent is left to the system. The intent may be distributed and enforced in individual points of the system or controlled by a central point. Even though context and implicit expectations are not part of the intent, they play important roles in an intent-based system.

It will be appreciated that the method described herein with reference to FIG. 3 may also in applicable for use in other contexts, in addition to the management of energy consumption in a network.

The one or more actions are proposed based on a current state of a system and an intent. In some embodiments, the one or more actions may be proposed by a recommender module in the system. Furthermore, in some embodiments the one or more actions may be proposed based on one of: a rule-based process for inferring actions given a state of the system, a logic-based process for inferring actions given a state of the system, a machine learning based recommending process trained using datasets encompassing states of the system and corresponding actions taken, and a reinforcement learning based process.

Moreover, the one or more actions may be proposed using a machine learning model trained on datasets encompassing states of the systems and actions taken corresponding to respective states, or they may be proposed using a reinforcement learning agent trained on simulators of the system.

With reference to FIG. 3, at step 310, a first explanation and a second explanation are acquired. For example, the first explanation may be acquired from a first subsystem of the system or a first external entity, and the second explanation may be acquired from a second subsystem of the system or a second external entity. The first subsystem and the second subsystem may be different subsystems in the system. The first external entity and the second external entity may be different entities. Alternatively, the first and second explanations may be acquired from the same subsystem or the same external entity in some embodiments.

The first and second explanations are associated with a proposed action or are associated with different actions, each of the first and second explanations including one or more constraints. Each constraint represents a requirement to satisfy a problem corresponding to the intent.

In some embodiments, each of the first explanation and the second explanation may corresponds to one of: a proof, a derivation, or a trace of rules applied to infer the respective proposed action given a state of the system, a set of mutually satisfiable constraints indicating corresponding variables and the value intervals within which the constraints remain satisfiable, one or more features or predicates and their corresponding values that have the greatest impact on the proposed action, and one or more properties or predicates and their corresponding values that are achieved executing the proposed action. For example, in the context of a rule-based process an exemplary rule may be “If A and B, then X, unless C”. In this case, A, B, and C may be referred to as “conditions” or “antecedents”, and X may be referred to as a “consequence”. Furthermore, in this case “A, B, and ˜C” (the latter read “not C”, where ˜refers to negation) would be the corresponding constraint forming at least a part of an explanation. In some embodiments, the first and/or second explanation may be represented as a list or a set of objects or symbols. For example, an assignment {f_1=v1, . . . , f_n=v_n} of variables/features f_i to values v_i is an explanation of some inference/classification, then any f_i=v_i can be regarded as a constraint.

Subsequently, at step 320, constraints from the first and second explanations are combined to form a set of constraints D.

Then, at step 330, a planning problem P=<K, A, I, G, Cost>is generated. In the planning problem P=<K, A, I, G, Cost>, K represents a “combined” set that consists of a set of predicates F in a domain of the system and the set of constraints D, A represents a set of possible actions associated with the first explanation and/or the second explanation, I represents an initial state of the system, G represents a goal state of the system corresponding to the intent, and Cost represents cost values associated with each constraint in the set of constraints.

Returning to FIG. 3, at step 340, a solution for the planning problem P is determined, the solution representing a consolidated explanation based on the first and second explanations. Determining a solution for the planning problem P at step 340 may be performed using an automatic planning progress and a constraint relaxation process.

In some embodiments, determining a solution for the planning problem at step 340 may comprise determining whether the planning problem P can be solved without relaxing one or more constraints in the set of constraints D. For example, this may be determined by employing known (automated) constraint solving technique(s) to check for satisfiability of constraint(s), or (automated) planning technique(s) to yield a plan. In these embodiments, if it is determined that the planning problem can be solved without relaxing one or more constraints in the set of constraints D, it may be further determined that the first and second explanations are complementary explanations as the solution of the planning problem.

Conversely, in these embodiments if it is determined that the planning problem P cannot be solved without relaxing one or more constraints in the set of constraints D, a plan may be determined as the solution for the planning problem. Determining a plan as the solution for the planning problem may comprise:
assigning a respective plan label to each of a plurality of subsets of constraints from the set of constraints D, each plan label being indicative of a respective candidate plan for the planning problem P,
determining a combination cost value for each of the plurality of candidate plans, wherein the combination cost value is a combination of a plan cost value and a constraint cost value, the plan cost value representing a cost of executing the respective candidate plan, and the constraint cost value representing a total violation cost caused by the respective subset of constraints of the respective candidate plan, and
selecting a candidate plan with the lowest combination cost value as the solution for the planning problem.

In some embodiments, determining a combination cost value for a respective candidate plan may comprise:
acquiring, from a knowledge base of the system, at least one of: an individual cost value for each constraint in the subset of constraints of the respective candidate plan, and an aggregate cost value for one or more subgroups of constraints in the subset of constraints of the respective candidate plan,
determining the constraint cost value for the respective candidate plan by summing the at least one of: individual cost values and aggregate cost values, and
determining the combination cost value by combining the constraint cost value with the plan cost value associated with the respective candidate plan.

In some embodiments, acquiring at least one of individual cost values and aggregate cost values may comprise acquiring the at least one of individual cost values and aggregate cost values from a previous solution plan of a planning problem stored in the knowledge base, the previous solution plan and constraints associated with the previous solution plan matching those of the respective candidate plan.

Each individual cost value and/or each aggregate cost value may be based on at least one of: the intent, one or more associated service level agreements, and a cost associated with the intent.

In some embodiments, determining a combination cost value may be performed using a constraint solving technique and a trained machine learning model.

In some embodiments, the method may further comprise storing the determined solution, for example at a knowledge base of the system.

FIG. 4 is a block diagram of an apparatus for consolidating explanations associated with one or more actions, according to embodiments of the disclosure. The apparatus 400 comprises processing circuitry 410 coupled with a memory 420. In some embodiments, the apparatus 400 may be a combined planner and explainer module.

The one or more actions are proposed based on a current state of a system and an intent. In some embodiments, the one or more actions may be proposed by a recommender module in the system, the one or more actions being proposed based on one of: a rule-based process for inferring actions given a state of the system, a logic-based process for inferring actions given a state of the system, a machine learning based recommending process trained using datasets encompassing states of the system and corresponding actions taken, and a reinforcement learning based process. The system may be at least part of a communication network, and the intent may represent an aggregate operational goal to be reached by the communication network. As explained above with reference to FIG. 3, the intent can be expressed the form of a declaration of high-level business and operational goals or states that the system should meet, but it does not refer to specification of events, conditions, or actions.

In some embodiments, the one or more actions may be proposed using a machine learning model trained on datasets encompassing states of the systems and actions taken corresponding to respective states, or they may be proposed using a reinforcement learning agent trained on simulators of the system.

When executed by the processing circuitry 410, the apparatus 400 is caused to acquire a first explanation and a second explanation, For example, the first explanation may be acquired from a first subsystem of the system or a first external entity, and the second explanation may be acquired from a second subsystem of the system or a second external entity. Alternatively, in some embodiments, the first and second explanations may be acquired from the same subsystem or the same external entity.

The first and second explanations are associated with a proposed action or are associated with different actions, and each of the first and second explanations including one or more constraints. Each constraint represents a requirement to satisfy a problem corresponding to the intent.

Each of the first explanation and the second explanation may correspond to one of: a proof, a derivation, or a trace of rules applied to infer the respective proposed action given a state of the system, a set of mutually satisfiable constraints indicating corresponding variables and the value intervals within which the constraints remain satisfiable, one or more features or predicates and their corresponding values that have the greatest impact on the proposed action, and one or more properties or predicates and their corresponding values that are achieved executing the proposed action.

The apparatus 400 is further caused to combine constraints from the first and second explanations to form a set of constraints D, and to generate a planning problem P=<K, A, I, G, Cost>. K consists of a set of predicates F in a domain of the system and the set of constraints D. A represents a set of possible actions associated with the first explanation and/or the second explanation. I represents an initial state of the system. G represents a goal state of the system corresponding to the intent. Cost represents cost values associated with each constraint in the set of constraints.

Moreover, the apparatus 400 is further caused to determine a solution for the planning problem P, the solution representing a consolidated explanation based on the first and second explanations. The apparatus 400 may be caused to determine the solution for the planning problem P using an automatic planning progress and a constraint relaxation process.

In some embodiments, the apparatus 400 may be caused to determine a solution for the planning problem by performing the below steps:
determining whether the planning problem P can be solved without relaxing one or more constraints in the set of constraints D (e.g., by employing known (automated) constraint solving technique(s) to check for satisfiability of constraint(s), or (automated) planning technique(s) to yield a plan)
if it is determined that the planning problem can be solved without relaxing one or more constraints in the set of constraints D, the apparatus 400 may be caused to determine that the first and second explanations are complementary explanations as the solution of the planning problem, or
if it is determined that the planning problem P cannot be solved without relaxing one or more constraints in the set of constraints D, the apparatus 400 may be caused to determine a plan as the solution for the planning problem.

In some embodiments, the apparatus 400 may be caused to determine a plan as the solution for the planning problem by:
assigning a respective plan label to each of a plurality of subsets of constraints from the set of constraints D, each plan label being indicative of a respective candidate plan for the planning problem P,
determining a combination cost value for each of the plurality of candidate plans, wherein the combination cost value is a combination of a plan cost value and a constraint cost value, the plan cost value representing a cost of executing the respective candidate plan, and the constraint cost value representing a total violation cost caused by the respective subset of constraints of the respective candidate plan, and
selecting a candidate plan with the lowest combination cost value as the solution for the planning problem.

In some embodiments, the apparatus 400 may be caused to determine a combination cost value for a respective candidate plan by:
acquiring, from a knowledge base of the system, at least one of: an individual cost value for each constraint in the subset of constraints of the respective candidate plan, and an aggregate cost value for one or more subgroups of constraints in the subset of constraints of the respective candidate plan,
determining the constraint cost value for the respective candidate plan by summing the at least one of: individual cost values and aggregate cost values, and
determining the combination cost value by combining the constraint cost value with the plan cost value associated with the respective candidate plan.

Each individual cost value and/or each aggregate cost value may be based on at least one of: the intent, one or more associated service level agreements, and a cost associated with the intent.

In some embodiments, the apparatus 400 may be caused to acquire the at least one of individual cost values and aggregate cost values by acquiring the at least one of individual cost values and aggregate cost values from a previous solution plan of a planning problem stored in the knowledge base. In these embodiments, the previous solution plan and constraints associated with the previous solution plan may match those of the respective candidate plan.

Furthermore, in some embodiments, the apparatus 400 may be caused to determine a combination cost value is performed using a constraint solving technique and a trained machine learning model.

In some embodiments, the apparatus 400 may be caused to store the determined solution for the planning problem P, for example at a knowledge base of the system.

It will be appreciated that FIG. 4 only shows the components required to illustrate an aspect of the apparatus 400 and, in a practical implementation, the apparatus 400 may comprise alternative or additional components to those shown.

It will also be appreciated that FIG. 4 only shows a manner in which an apparatus for consolidating explanations associated with one or more actions may be implemented. In alternative embodiments, there may be provided an apparatus for consolidating explanations associated with one or more actions proposed based on a current state of a system and an intent, the apparatus being configured to perform the method as described with reference to the flowchart of FIG. 3.

It will also be appreciated that in other alternative embodiments, there may be provided an apparatus for consolidating explanations associated with one or more actions proposed based on a current state of a system and an intent, the apparatus comprising acquiring module configured to acquire a first explanation and a second explanation, combining module configured to combine constraints from the first and second explanations to form a set of constraints D, generating module configured to generate a planning problem P=<K, A, I, G, Cost>, and determining module configured to determine a solution for the planning problem P, the solution representing a consolidated explanation based on the first and second explanations. In these embodiments, the first and second explanations are associated with a proposed action or are associated with different actions, and each of the first and second explanations includes one or more constraints, each constraint representing a requirement to satisfy a problem corresponding to the intent. Furthermore, in these embodiments, K consists of a set of predicates F in a domain of the system and the set of constraints D, A represents a set of possible actions associated with the first explanation and/or the second explanation, I represents an initial state of the system, G represents a goal state of the system corresponding to the intent, and Cost represents cost values associated with each constraint in the set of constraints.

Any appropriate steps, methods, or functions may be performed through a computer program product that may, for example, be executed by the components and equipment illustrated in the figure above. For example, the memory 420 at the apparatus 400 may comprise non-transitory computer readable means on which a computer program or a computer program product can be stored. The computer program or computer program product may include instructions which, when executed (e.g. by processing circuitry of an apparatus) cause the components of the apparatus 400 or any operatively coupled entities and devices) to perform methods according to embodiments described herein. The computer program and/or computer program product may thus provide means for performing any steps herein disclosed.

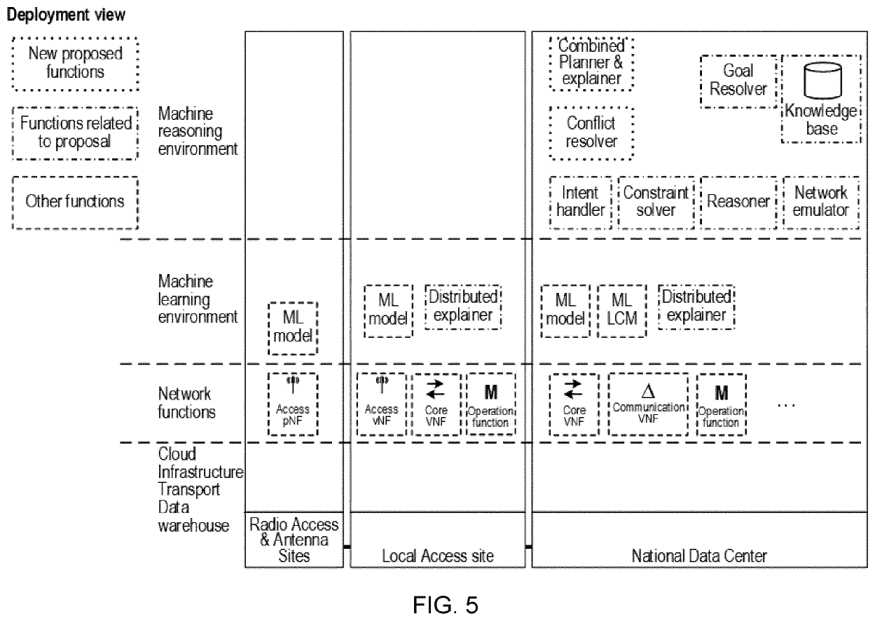

FIG. 5 is a schematic diagram illustrating a deployment view of a machine reasoning environment including a combined planner and explainer module and a conflict resolver component, according to embodiments of the present disclosure.

As shown in FIG. 5, the deployment as shown includes a plurality of layers respective representing, from top to bottom, a machine reasoning environment, a machine learning environment, network functions, and cloud infrastructure transport data warehouse. Furthermore, these layers are each divided by location: radio access and antenna sites, local access site, and national data center.

The combined planner and explainer module and the conflict resolver component as described above, in particular with reference to FIGS. 1B and 2, can be implemented in the machine reasoning environment at the national data center alongside a goal resolver module, a knowledge base, an intent handler module, a constraint solver module, a reasoner module, and an network emulator module, all of which are functions related to the technique proposed herein as explained above. Also, as shown in FIG. 5, there are provided distributed explainer modules provided at the machine learning environment, both at the local access site along a machine learning model, and at the national data center alongside a machine learning model and a machine learning Life Cycle Management (LCM). The distributed explainer modules are also functions relating to the technique proposed herein—in some embodiments explanations may be acquired from these distributed explainer modules.

Embodiments of the disclosure thus propose methods and apparatuses for consolidating explanations associated with one or more actions proposed based on a current state of a system and an intent which enable conflict resolution when explanations from different subsystems/systems/entities are not matching, and also enable confirmation in scenarios where explanations from different subsystems/systems/entities are complementary to each other.

The above disclosure sets forth specific details, such as particular embodiments or examples for purposes of explanation and not limitation. It will be appreciated by one skilled in the art that other examples may be employed apart from these specific details.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A computer-implemented method for consolidating explanations associated with one or more actions proposed based on a current state of a system and an intent, the method comprising:
acquiring a first explanation and a second explanation, wherein the first and second explanations are associated with a proposed action or are associated with different actions, and wherein each of the first and second explanations includes one or more constraints, each constraint representing a requirement to satisfy a problem corresponding to the intent;
combining constraints from the first and second explanations to form a set of constraints D;
generating a planning problem P=<K, A, I, G, Cost>, wherein K consists of a set of predicates F in a domain of the system and the set of constraints D, wherein A represents a set of possible actions associated with the first explanation and/or the second explanation, I represents an initial state of the system, G represents a goal state of the system corresponding to the intent, and Cost represents cost values associated with each constraint in the set of constraints; and
determining a solution for the planning problem P, wherein the solution represents a consolidated explanation based on the first and second explanations.

2. The method according to claim 1, wherein determining a solution for the planning problem comprises determining whether the planning problem P can be solved without relaxing one or more constraints in the set of constraints D, and
if it is determined that the planning problem can be solved without relaxing one or more constraints in the set of constraints D, determining that the first and second explanations are complementary explanations as the solution of the planning problem, or
if it is determined that the planning problem P cannot be solved without relaxing one or more constraints in the set of constraints D, determining a plan as the solution for the planning problem.

3. The method according to claim 2, wherein determining a plan as the solution for the planning problem comprises:
assigning a respective plan label to each of a plurality of subsets of constraints from the set of constraints D, wherein each plan label is indicative of a respective candidate plan for the planning problem P;
determining a combination cost value for each of the plurality of candidate plans, wherein the combination cost value is a combination of a plan cost value and a constraint cost value, the plan cost value representing a cost of executing the respective candidate plan, and the constraint cost value representing a total violation cost caused by the respective subset of constraints of the respective candidate plan; and
selecting a candidate plan with the lowest combination cost value as the solution for the planning problem.

4. The method according to claim 3, wherein determining a combination cost value for a respective candidate plan comprises:
acquiring, from a knowledge base of the system, at least one of: an individual cost value for each constraint in the subset of constraints of the respective candidate plan, and an aggregate cost value for one or more subgroups of constraints in the subset of constraints of the respective candidate plan;
determining the constraint cost value for the respective candidate plan by summing the at least one of: individual cost values and aggregate cost values; and
determining the combination cost value by combining the constraint cost value with the plan cost value associated with the respective candidate plan.

5. The method according to claim 4, wherein acquiring at least one of individual cost values and aggregate cost values comprises:
acquiring the at least one of individual cost values and aggregate cost values from a previous solution plan of a planning problem stored in the knowledge base, wherein the previous solution plan and constraints associated with the previous solution plan match those of the respective candidate plan.

6. The method according to claim 4, wherein each individual cost value and/or each aggregate cost value is based on at least one of: the intent, one or more associated service level agreements, and a cost associated with the intent.

7. The method according to claim 3, wherein determining a combination cost value is performed using a constraint solving technique and a trained machine learning model.

8. The method according to claim 1, wherein the one or more actions are proposed by a recommender module in the system, and wherein the one or more actions are proposed based on one of: a rule-based process for inferring actions given a state of the system, a logic-based process for inferring actions given a state of the system, a machine learning based recommending process trained using datasets encompassing states of the system and corresponding actions taken, and a reinforcement learning based process.

9. The method according to claim 1, wherein each of the first explanation and the second explanation corresponds to one of: a proof, a derivation, or a trace of rules applied to infer the respective proposed action given a state of the system, a set of mutually satisfiable constraints indicating corresponding variables and the value intervals within which the constraints remain satisfiable, one or more features or predicates and their corresponding values that have the greatest impact on the proposed action, and one or more properties or predicates and their corresponding values that are achieved executing the proposed action.

10. The method according to claim 1, wherein the system is at least part of a communication network, and the intent represents an aggregate operational goal to be reached by the communication network.

11. The method according to claim 1, wherein the method is performed at a combined planner and explainer module in the system.

12. The method according to claim 1, wherein the one or more actions are proposed using a machine learning model trained on datasets encompassing states of the systems and actions taken corresponding to respective states, or wherein the one or more actions are proposed using a reinforcement learning agent trained on simulators of the system.

13. The method according to claim 1, wherein the first explanation is acquired from a first subsystem of the system or a first external entity, and the second explanation is from a second subsystem of the system or a second external entity.

14. The method according to claim 1, wherein determining a solution for the planning problem P is performed using an automatic planning progress and a constraint relaxation process.

15. A computer program product, embodied on a non-transitory machine-readable medium, comprising instructions which are executable by processing circuitry to cause the processing circuitry to perform the method according to claim 1.

16. (canceled)

17. An apparatus for consolidating explanations associated with one or more actions proposed based on a current state of a system and an intent, the apparatus comprising processing circuitry coupled with a memory, wherein the memory comprises computer readable program instructions that, when executed by the processing circuitry, cause the apparatus to:
acquire a first explanation and a second explanation, wherein the first and second explanations are associated with a proposed action or are associated with different actions, and wherein each of the first and second explanations includes one or more constraints, each constraint representing a requirement to satisfy a problem corresponding to the intent;
combine constraints from the first and second explanations to form a set of constraints D;
generate a planning problem P=<K, A, I, G, Cost>, wherein K consists of a set of predicates F in a domain of the system and the set of constraints D, wherein A represents a set of possible actions associated with the first explanation and/or the second explanation, I represents an initial state of the system, G represents a goal state of the system corresponding to the intent, and Cost represents cost values associated with each constraint in the set of constraints; and
determine a solution for the planning problem P, wherein the solution represents a consolidated explanation based on the first and second explanations.

18. (canceled)
